(19) United States
(12) Patent Application Publication
(10) Pub. No.: US 2022/0332946 A1
(43) Pub. Date: Oct. 20, 2022

(54) THERMOPLASTIC URETHANES CONTAINING COMPOSITIONS

(71) Applicant: Braskem S.A., Camaçari (BR)

(72) Inventors: Kevin Herrington, Philadelphia, PA (US); Nei Sebastião Domingues Junior, São Paulo City (BR); Hadi Mohammadi, Philadelphia, PA (US)

(73) Assignee: Braskem S.A., Camaçari (BR)

(21) Appl. No.: 17/715,709

(22) Filed: Apr. 7, 2022

Related U.S. Application Data
(60) Provisional application No. 63/171,916, filed on Apr. 7, 2021.

(51) Int. Cl. C08L 75/06; C08L 75/08; C08J 9/00

(52) U.S. Cl. CPC C08L 75/06; C08L 75/08; C08J 9/0061; C08L 2203/30; C08L 2203/14; C08L 2205/03; C08L 2205/08; C08L 2312/00; C08J 2375/06; C08J 2375/08; C08J 2423/08; C08J 2415/00; C08J 2409/06

(57) ABSTRACT

A polymer composition may include a polymer produced from ethylene, one or more branched vinyl ester monomers, optionally vinyl acetate (VA), and a thermoplastic polyurethane (TPU). A method of preparing a polymer composition may include blending a thermoplastic polyurethane (TPU) and an ethylene based polymer produced from ethylene, one or more branched vinyl ester monomers, and optionally vinyl acetate (VA); and to form a blended mixture; and extruding the blended mixture to form the polymer composition

### BACKGROUND

Thermoplastic polyurethanes or TPUs are thermoplastics produced from the reaction between macroglycols, diisocyanates and short chain diols. They exhibit elastomeric as well as thermoplastic properties. Thermoplastic polyurethanes have been used in various applications such as sporting goods, automotive, injection molded technical parts, soft-touch household goods, tubes and profiles, films and sheets, textiles, seals and gaskets, etc., because of their beneficial properties such as high abrasion resistance, high shear strength, and high elasticity.

Traditionally TPUs follow a trend where a decrease in hardness leads to a decrease in tensile properties, modulus, and strength. There remains a need in the art to develop polymers with decreased hardness while maintaining tensile properties.

SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one or more aspect, embodiments disclosed herein relate to a polymer composition that includes a polymer produced from ethylene, one or more branched vinyl ester monomers, and optionally, vinyl acetate; and a thermoplastic polyurethane (TPU).

In another aspect, embodiments disclosed herein relate to a method for producing a polymer composition including blending a thermoplastic polyurethane (TPU) polymer and a vinyl ester containing copolymer to form a polymer composition, wherein the vinyl ester containing copolymer comprises ethylene, one or more branched vinyl ester monomers, and optionally, vinyl acetate.

In one or more aspect, embodiments disclosed herein relate to an article prepared from a polymer composition that includes a polymer produced from ethylene, one or more branched vinyl ester monomers, and optionally, vinyl acetate; and a thermoplastic polyurethane (TPU).

Other aspects and advantages of the claimed subject matter will be apparent from the following description and the appended claims.

### BRIEF DESCRIPTION OF DRAWINGS

FIG. 1 is a graphical representation of the tensile data of TPU blends in one or more embodiments of the present disclosure.

FIG. 2 is a graphical representation of the tensile data of TPU blends in one or more embodiments of the present disclosure.

FIG. 3A is an Atomic Force Micrograph of a reference TPU blend.

FIG. 3B is an Atomic Force Micrograph of a reference TPU blend.

FIG. 3C is an Atomic Force Micrograph of TPU blends in one or more embodiments of the present disclosure.

FIG. 3D is an Atomic Force Micrograph of TPU blends in one or more embodiments of the present disclosure.

FIG. 3E is an Atomic Force Micrograph of TPU blends in one or more embodiments of the present disclosure.

### DETAILED DESCRIPTION

In one aspect, embodiments disclosed herein relate to polymer compositions containing ethylene based polymers prepared from ethylene and one or more branched vinyl ester monomers, and a thermoplastic polyurethane (TPU). Such polymer compositions may allow for a decreased hardness and improved haptics (as compared to the TPU alone) while maintaining tensile strength, lower glass transition temperature (Tg), and higher abrasion resistance.

While EVA may be used to reduce hardness in a TPU-containing composition, ethylene based polymers including at least ethylene and a branched vinyl ester blended with TPU may advantageously achieve such effects at a lower loading as compared to EVA. In one or more embodiments, polymer compositions may be expanded to produce articles having a good combination of properties, such as low operating temperatures and better wear behavior than current solutions. Such polymer compositions may be useful in a variety of applications including shoe sole or a shoe part, film, tube, fiber, cable, ear tag, automotive part, automobile part, hose, belt, damping element, armrest, furniture element, ski boot, stop buffer, roller, ski goggle, powder slush, aerials and aerial feet, handles, housing, switch, and cladding and cladding element.

Polymer compositions in accordance with the present disclosure may include ethylene based polymers incorporating various ratios of ethylene and one or more branched vinyl esters. In some embodiments, polymer compositions may be prepared by reacting ethylene and a branched vinyl ester in the presence of additional comonomers in a high-pressure polymerization process. In other embodiments, terpolymers may be similarly prepared by additionally incorporating a vinyl acetate monomer. In one or more embodiments, the polymer compositions may include polymers generated from monomers derived from petroleum and/or renewable sources.

Polymer Compositions

Polymer compositions disclosed herein include a suitable amount of a thermoplastic polyurethane and a suitable amount of a polymer produced from ethylene, one or more branched vinyl ester monomers, and optionally, vinyl acetate. It is also envisioned that the polymer compositions disclosed herein may optionally include one or more of a compatibilizer, a crosslinking agent, a foaming agent, an accelerant, and an elastomer.

Ethylene Based Polymer

In one or more embodiments, polymer compositions disclosed herein include a suitable amount of an ethylene based polymer produced from ethylene, one or more branched vinyl ester monomers (as a copolymer), and optionally, vinyl acetate (as a terpolymer). In some embodiments, polymer compositions include 5 to 85 wt % (weight percent) of an ethylene based polymer produced from ethylene, one or more branched vinyl ester monomers, and optionally, vinyl acetate. The polymer produced from ethylene, one or more branched vinyl ester monomers, and optionally, vinyl acetate may be present in the polymer composition in an amount ranging from a lower limit of one of 0.5, 1, 2.5, 5, 15, 20, 25, 30, 35, 40 or 45 wt % and an upper limit of 50, 55, 60, 65, 70, 75, 80 and 85 wt %, where any lower limit may be combined with any mathematically compatible upper limit.

Polymer compositions in accordance with the present disclosure may include ethylene based polymers incorporating various ratios of ethylene and one or more branched vinyl esters. In some embodiments, polymer compositions may be prepared by reacting ethylene and a branched vinyl ester in the presence of additional comonomers in a high-pressure polymerization process. In other embodiments, terpolymers may be similarly prepared by additionally incorporating a vinyl acetate monomer. In one or more embodiments, the polymer compositions may include polymers generated from monomers derived from petroleum and/or renewable sources.

Branched Vinyl Ester Monomers

As mentioned above, the polymer compositions may include an ethylene based polymer that includes a branched vinyl ester monomer. In one or more embodiments, branched vinyl esters may include branched vinyl esters generated from isomeric mixtures of branched alkyl acids. Branched vinyl esters in accordance with the present disclosure may have the general chemical formula (I):

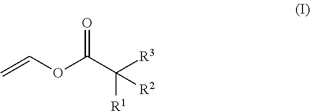

where R¹, R², and R³ have a combined carbon number in the range of C3 to C20. In some embodiments, R¹, R², and R³ may all be alkyl chains having varying degrees of branching in some embodiments, or a subset of R¹, R², and R³ may be independently selected from a group consisting of hydrogen, alkyl, or aryl in some embodiments.

In one or more embodiments, the branched vinyl esters may have the general chemical formula (II):

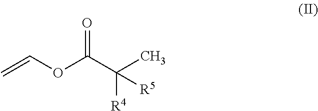

wherein R⁴ and R⁵ have a combined carbon number of 6 or 7 and the polymer composition has a number average molecular weight (Mₙ) ranging from 5 kDa to 10000 kDa obtained by GPC. In one or more embodiments, R⁴ and R⁵ may have a combined carbon number of less than 6 or greater than 7, and the polymer composition may have an Mₙ up to 10000 kDa. That is, when the Mₙ is less than 5 kDa, R⁴ and R⁵ may have a combined carbon number of less than 6 or greater than 7, but if the Mₙ is greater than 5 kDa, such as in a range from 5 to 10000 kDa, R⁴ and R⁵ may include a combined carbon number of 6 or 7. In particular embodiments, R⁴ and R⁵ have a combined carbon number of 7, and the Mₙ may range from 5 to 10000 kDa. Further in one or more particular embodiments, a branched vinyl ester according to Formula (II) may be used in combination with vinyl acetate.

Examples of branched vinyl esters may include monomers having the chemical structures, including derivatives thereof:

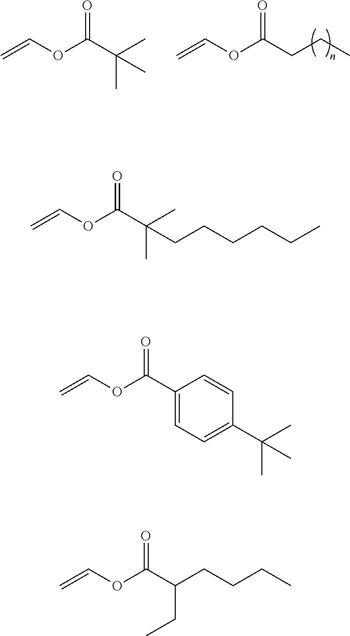

In one or more embodiments, the polymer compositions may include polymers generated from monomers derived from petroleum and/or renewable sources.

In one or more embodiments, branched vinyl esters may include monomers and comonomer mixtures containing vinyl esters of neononanoic acid, neodecanoic acid, and the like. In some embodiments, branched vinyl esters may include Versatic™ acid series tertiary carboxylic acids, including Versatic™ acid EH, Versatic™ acid 9 and Versatic™ acid 10 prepared by Koch synthesis, commercially available from Hexion™ chemicals.

Ethylene based polymers in accordance with the present disclosure may include a percent by weight of ethylene measured by proton nuclear magnetic resonance (¹H NMR) and Carbon 13 nuclear magnetic resonance (¹³C NMR) that ranges from a lower limit selected from one of 70 wt %, 75 wt %, and 80 wt %, to an upper limit selected from one of 85 wt %, 90 wt %, 95 wt %, 99.9 wt %, and 99.99 wt % where any lower limit may be paired with any upper limit.

Ethylene based polymers in accordance with the present disclosure may include a percent by weight of vinyl ester monomer, such as that of Formula (I) and (II) above, measured by ¹H NMR and ¹³C NMR that ranges from a lower limit selected from one of 0.01 wt %, 0.1 wt %, 1 wt %, 5 wt %, 10 wt %, 20 wt %, or 30 wt % to an upper limit selected from 50 wt %, 60 wt %, 70 wt %, 80 wt %, 89.99 wt %, or 90 wt % where any lower limit may be paired with any upper limit.

Ethylene based polymers in accordance with the present disclosure may include a percent by weight of vinyl acetate measured by ¹H NMR and ¹³C NMR that ranges from a lower limit selected from one of 0.01 wt %, 0.1 wt %, 1 wt %, 2 wt %, 5 wt %, 10 wt %, 12 wt %, 15 wt %, 20 wt %, or 30 wt % to an upper limit selected from 20 wt %, 30 wt %, 33 wt %, 35 wt %, 40 wt %, 50 wt %, 60 wt %, 70 wt %, 80 wt %, or 89.99 wt % where any lower limit may be paired with any upper limit.

Ethylene based polymers in accordance with the present disclosure may have a number average molecular weight (Mₑ) in kilodaltons (kDa) measured by gel permeation chromatography (GPC) that ranges from a lower limit selected from one of 1 kDa, 5 kDa, 10 kDa, 15 kDa, and 20 kDa to an upper limit selected from one of 40 kDa, 50 kDa, 100 kDa, 300 kDa, 500 kDa, 1000 kDa, 5000 kDa, and 10000 kDa, where any lower limit may be paired with any upper limit.

Ethylene based polymers in accordance with the present disclosure may have a weight average molecular weight (M_{w}) in kilodaltons (kDa) measured by GPC that ranges from a lower limit selected from one of 1 kDa, 5 kDa, 10 kDa, 15 kDa and 20 kDa to an upper limit selected from one of 40 kDa, 50 kDa, 100 kDa, 200 kDa, 300 kDa, 500 kDa, 1000 kDa, 2000 kDa, 5000 kDa, 10000 kDa, and 20000 kDa, where any lower limit may be paired with any upper limit.

Ethylene based polymers in accordance with the present disclosure may have a molecular weight distribution (MWD, defined as the ratio of M_{w} over Mₙ) measured by GPC that has a lower limit of any of 1, 2, 5, or 10, and an upper limit of any of 20, 30, 40, 50, or 60, where any lower limit may be paired with any upper limit.

In some embodiments, ethylene based polymers may be polymerized in the presence of one or more initiators for radical polymerization capable of generating free radicals that initiate chain polymerization of comonomers and prepolymers in a reactant mixture. In one or more embodiments, radical initiators may include chemical species that degrade to release free radicals spontaneously or under stimulation by temperature, pH, or other triggers.

In one or more embodiments, radical initiators may include peroxides and bifunctional peroxides such as benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyneodecanoate; t-butyl-peroxy-benzoate; t-butyl-peroxy-2-ethyl-hexanoate; tert-butyl 3,5,5-trimethylhexanoate peroxide; tert-butyl peroxybenzoate; 2-ethylhexyl carbonate tert-butyl peroxide; 2,5-dimethyl-2,5-di (tert-butylperoxide) hexane; 1,1-di (tert-butylperoxide)-3,3,5-trimethylcyclohexane; 2,5-dimethyl-2,5-di(tert-butylperoxide) hexyne-3; 3,3,5,7,7-pentamethyl-1,2,4-trioxepane; butyl 4,4-di (tert-butylperoxide) valerate; di (2,4-dichlorobenzoyl) peroxide; di(4-methylbenzoyl) peroxide; peroxide di(tert-butylperoxyisopropyl) benzene; and the like.

Radical initiators may also include benzoyl peroxide, 2,5-di(cumylperoxy)-2,5-dimethyl hexane, 2,5-di(cumylperoxy)-2,5-dimethyl hexyne-3,4-methyl-4-(t-butylperoxy)-2-pentanol, 4-methyl-4-(t-amylperoxy)-2-pentano1,4-methyl-4-(cumylperoxy)-2-pentanol, 4-methyl-4-(t-butylperoxy)-2-pentanone, 4-methyl-4-(t-amylperoxy)-2-pentanone, 4-methyl-4-(cumylperoxy)-2-pentanone, 2,5-dimethyl-2,5-di(t-butylperoxy)hexane, 2,5-dimethyl-2,5-di(t-amylperoxy)hexane, 2,5-dimethyl-2,5-di(t-butylperoxy)hexyne-3, 2,5-dimethyl-2,5-di(t-amylperoxy)hexyne-3,2,5-dimethyl-2-t-butylperoxy-5-hydroperoxyhexane, 2,5-dimethyl-2-cumylperoxy-5-hydroperoxy hexane, 2,5-dimethyl-2-t-amylperoxy-5-hydroperoxyhexane, m/p-alpha, alpha-di[(t-butylperoxy)isopropyl]benzene, 1,3,5-tris(t-butylperoxyisopropyl)benzene, 1,3,5-tris(t-amylperoxyisopropyl)benzene, 1,3,5-tris(cumylperoxyisopropyl)benzene, di[1,3-dimethyl-3-(t-butylperoxy)butyl]carbonate, di[1,3-dimethyl-3-(t-amylperoxy)butyl]carbonate, di[1,3-dimethyl-3-(cumylperoxy)butyl]carbonate, di-t-amyl peroxide, t-amyl cumyl peroxide, t-butyl-isopropenylcumyl peroxide, 2,4,6-tri(butylperoxy)-s-triazine, 1,3,5-tri[1-(t-butylperoxy)-1-methylethyl]benzene, 1,3,5-tri-[(t-butylperoxy)-isopropyl]benzene, 1,3-dimethyl-3-(t-butylperoxy)butanol, 1,3-dimethyl-3-(t-amylperoxy)butanol, di(2-phenoxyethyl)peroxydicarbonate, di(4-t-butylcyclohexyl)peroxydicarbonate, dimyristyl peroxydicarbonate, dibenzyl peroxydicarbonate, di(isobomyl)peroxydicarbonate, 3-cumylperoxy-1,3-dimethylbutyl methacrylate, 3-t-butylperoxy-1,3-dimethylbutyl methacrylate, 3-t-amylperoxy-1,3-dimethylbutyl methacrylate, tri(1,3-dimethyl-3-t-butylperoxy butyloxy)vinyl silane, 1,3-dimethyl-3-(t-butylperoxy)butyl N-[1-1-{3-(1-methylethenyl)-phenyl) 1-methylethyl]carbamate, 1,3-dimethyl-3-(t-amylperoxy)butyl N-[1-{3 (1-methylethenyl)-phenyl}-1-methylethyl]carbamate, 1,3-dimethyl-3-(cumylperoxy))butyl N-[1-{3-(1-methylethenyl)-phenyl}-1-methylethyl]carbamate, 1,1-di(t-butylperoxy)-3,3,5-trimethylcyclohexane, 1,1-di(t-butylperoxy)cyclohexane, n-butyl 4,4-di(t-amylperoxy)valerate, ethyl 3,3-di(t-butylperoxy)butyrate, 2,2-di(t-amylperoxy)propane, 3,6,6,9,9-pentamethyl-3-ethoxycabonylmethyl-1,2,4,5-tetraoxacyclononane, n-butyl-4,4-bis(t-butylperoxy)valerate, ethyl-3,3-di(t-amylperoxy)butyrate, benzoyl peroxide, OO-t-butyl-O-hydrogen-monoperoxy-succinate, OO-t-amyl-O-hydrogen-monoperoxy-succinate, 3,6,9, triethyl-3,6,9-trimethyl-1,4,7-triperoxynonane (or methyl ethyl ketone peroxide cyclic trimer), methyl ethyl ketone peroxide cyclic dimer, 3,3,6,6,9,9-hexamethyl-1,2,4,5-tetraoxacyclononane, 2,5-dimethyl-2,5-di(benzoylperoxy)hexane, t-butyl perbenzoate, t-butylperoxy acetate, t-butylperoxy-2-ethyl hexanoate, t-amyl perbenzoate, t-amyl peroxy acetate, t-butyl peroxy isobutyrate, 3-hydroxy-1,1-dimethyl t-butyl peroxy-2-ethyl hexanoate, OO-t-amyl-O-hydrogen-monoperoxy succinate, OO-t-butyl-O-hydrogen-monoperoxy succinate, di-t-butyl diperoxyphthalate, t-butylperoxy (3,3,5-trimethylhexanoate), 1,4-bis(t-butylperoxycarbo)cyclohexane, t-butylperoxy-3,5,5-trimethylhexanoate, t-butyl-peroxy-(cis-3-carboxy)propionate, allyl 3-methyl-3-t-butylperoxy butyrate, OO-t-butyl-O-isopropylmonoperoxy carbonate, OO-t-butyl-O-(2-ethyl hexyl) monoperoxy carbonate, 1,1,1-tris[2-(t-butylperoxy-carbonyloxy)ethoxymethyl]propane, 1,1,1-tris[2-(t-amylperoxy-carbonyloxy)ethoxymethyl]propane, 1,1,1-tris[2-(cumylperoxy-cabonyloxy)ethoxymethyl]propane, OO-t-amyl-O-isopropylmonoperoxy carbonate, di(4-methylbenzoyl)peroxide, di(3-methylbenzoyl)peroxide, di(2-methylbenzoyl)peroxide, didecanoyl peroxide, dilauroyl peroxide, 2,4-dibromo-benzoyl peroxide, succinic acid peroxide, dibenzoyl peroxide, di(2,4-dichloro-benzoyl)peroxide, and combinations thereof.

In one or more embodiments, radical initiators may include azo-compounds such as azobisisobutyronitrile (AIBN), 2,2′-azobis(amidinopropyl) dihydrochloride, and the like, azo-peroxide initiators that contain mixtures of peroxide with azodinitrile compounds such as 2,2′-azobis(2-methyl-pentanenitrile, 2,2′-azobis(2-methyl-butanenitrile), 2,2′-azobis(2-ethyl-pentanenitrile), 2-[(1-cyano-1-methylpropyl)azo]-2-methyl-pentanenitrile, 2-[(1-cyano-1-ethylpropyl)azo]-2-methyl-butanenitrile, 2-[(1-cyano-1-methylpropyl)azo]-2-ethyl, and the like.

In one or more embodiments, radical initiators may include Carbon-Carbon (“C—C”) free radical initiators such as 2,3-dimethyl-2,3-diphenylbutane, 3,4-dimethyl-3,4-diphenylhexane, 3,4-diethyl-3,4-diphenylhexane, 3,4-dibenzyl-3,4ditolylhexane, 2,7-dimethyl-4,5-diethyl-4,5-diphenyloctane, 3,4-dibenzyl-3,4-diphenylhexane, and the like.

In one or more embodiments, ethylene based polymers polymerization may include one or more radical initiators present at a percent by weight of the total polymerization mixture (wt %) that ranges from a lower limit selected from any of 0.000001 wt %, 0.0001 wt %, 0.01 wt %, 0.1 wt %, 0.15 wt %, 0.4 wt %, 0.6 wt %, 0.75 wt % and 1 wt %, to an upper limit selected from any of 0.5 wt %, 1.25 wt %, 2 wt %, 4 wt %, and 5 wt %, where any lower limit can be used with any upper limit. Further, it is envisioned that the concentration of the radical initiator may be more or less depending on the application of the final material.

In some embodiments, ethylene based polymers may be polymerized in the presence of one or more stabilizers capable of preventing polymerization in the feed lines of monomers and comonomers but not hindering polymerization at the reactor.

In one or more embodiments, stabilizers may include nitroxyl derivatives such as 2,2,6,6-tetramethyl-1-piperidinyloxy, 2,2,6,6-tetramethyl-4-hydroxy-1-piperidinyloxy, 4-oxo-2,2,6,6-tetramethyl-1-piperidinyloxy, 2,2,6,6-tetramethyl-4-amino-piperidinyloxy, and the like.

In one or more embodiments, ethylene based polymers may contain stabilizers present at a percent by weight of the total polymerization mixture (wt %) that ranges from a lower limit selected from any of 0.000001 wt %, 0.0001 wt %, 0.01 wt %, 0.1 wt %, 0.15 wt %, 0.4 wt %, 0.6 wt %, 0.75 wt % and 1 wt %, to an upper limit selected from any of 0.5 wt %, 1.25 wt %, 2 wt %, 4 wt %, and 5 wt %, where any lower limit may be paired with any upper limit. Further, it is envisioned that the concentration of the stabilizer may be more or less depending on the application of the final material.

In some embodiments, ethylene based polymers may be polymerized in the presence of a chain transfer agent. Examples of chain transfer agents may include propylene, ethane, propane, methane, trimethylamine, dimethylamine, chloroform, and carbon tetrachloride. The chain transfer agent may be present by weight of the total total polymerization mixture (wt %) that ranges from a lower limit selected from one of 0.0000001 wt %, 0.000001 wt %, 0.001 wt %, 0.01 wt %, 0.02 wt %, 0.05 wt %, 1.0 wt % to an upper limit selected from one of 2.0 wt %, 3.0 wt %, 4.0 wt %, 5.0 wt %, where any lower limit can be used with any upper limit.

In one or more embodiments, ethylene based polymers may be prepared in a reactor by polymerizing ethylene and one or more branched vinyl esters monomers. Methods of reacting the comonomers in the presence of a radical initiator may include any suitable method in the art including solution phase polymerization, pressurized radical polymerization, bulk polymerization, emulsion polymerization, and suspension polymerization.

In some embodiments, the reactor may be a batch or continuous reactor at pressures below 500 bar, known as low pressure polymerization system. In one or more embodiments, the reaction may be carried out in a low pressure polymerization process wherein the ethylene and one or more vinyl ester monomers are polymerized in a liquid phase of an inert solvent and/or one or more liquid monomer(s).

In some embodiments, polymerization may comprise initiators for free-radical polymerization in an amount from about 0.0001 to about 0.01 calculated as the total amount of one or more initiator for free-radical polymerization per liter of the volume of the polymerization zone. The amount of ethylene in the polymerization zone may depend mainly on the total pressure of the reactor in a range from about 20 bar to about 500 bar and temperature in a range from about 20° C. to about 300° C.

In one or more embodiments, the pressure in the reactor may range from a lower limit of any of 20, 30, 40, 50, 75, or 100 bar, to an upper limit of any of 100, 150, 200, 250, 300, 350, 400, 450, or 500 bar and the temperature in the reactor may range from a lower limit of any of 20° C., 50° C., 75° C. or 100° C., to an upper limit of any of 150° C., 200° C., 250° C., 300° C., where any lower limit may be paired with any upper limit.

The polymerization mixture of the polymerization process in accordance with the present disclosure may include ethylene, one or more vinyl ester monomer, initiator for free-radical polymerization, and optionally one or more inert solvent such as tetrahydrofuran (THF), chloroform, dichloromethane (DCM), dimethyl sulfoxide (DMSO), dimethyl carbonate (DMC), hexane, cyclohexane, ethyl acetate (EtOAc) acetonitrile, toluene, xylene, ether, dioxane, dimethyl-formamide (DMF), benzene or acetone. Etheylene based polymers produced under low-pressure conditions may exhibit number average molecular weights of 1 to 300 kDa, weight average molecular weights of 1 to 1000 kDa and MWDs of 1 to 60.

In some embodiments, the comonomers and one or more free-radical polymerization initiators are polymerized to produce an ethylene based polymer in a continuous or batch process at temperatures above 50° C. and at pressures above 1000 bar, known as high pressure polymerization systems. For example, a pressure of greater than 1000, 1100, 1200, 1500, 1600, 1700, 1800, 1900, 2000, 2100, 2200, 2300, 2400, 2500, 3000, 5000, or 10000 bar may be used. The vinyl ester containing copolymer, which may be a copolymer or a terpolymer, produced under high-pressure conditions may have number average molecular weights (Mn) of 1 to 10000 kDa, weight average molecular weights (Mw) of 1 to 20000 kDa. Molecular weight distribution (MWD) is obtained from the ratio between the weight average molecular weight (Mw) and the number average molecular weight (Mn) obtained by GPC. Copolymers and terpolymers produced under high-pressure conditions may have MWDs of 1 to 60. The GPC experiments may be carried out by analytical methods such as gel permeation chromatography coupled with triple detection, with an infrared detector IR5 and a four bridge capillary viscometer, both from PolymerChar and an eight angle light scattering detector from Wyatt. A set of 4 column, mixed bed, 13 μm from Tosoh in a temperature of 140° C. may be used. Conditions of the experiments may be: concentration of 1 mg/mL, flow rate of 1 mL/min, dissolution temperature and time of 160° C. and 90 minutes, respectively and an injection volume of 200 μL. The solvent used is TCB (Trichloro benzene) stabilized with 100 ppm of BHT.

In some embodiments, the conversion during polymerization in low pressure polymerization and high pressure polymerization systems, which is defined as the weight or mass flow of the produced polymer divided by the weight of mass flow of monomers and comonomers may have a lower limit of any of 0.01%, 0.1%, 1%, 2%, 5%, 7%, 10% and an upper limit of any of 15%, 17%, 20%, 25%, 30%, 35%, 40%, 45%, 50%, 60%, 70%, 80%, 90%, 99% or 100%, where any lower limit may be paired with any upper limit.

Thermoplastic Polyurethanes

The TPU copolymer is a block copolymer containing domains formed by the reaction of a diisocyanate, a chain extender or short-chain diol, and a polyol or long-chain diol. Any type of TPU copolymer known to one skilled in the art is suitable to be used herein. Various types of TPU copolymers can be produced by varying the ratio, structure, and/or molecular weight of the above reaction components, to fine-tune the TPU copolymer's structure to the desired final properties of the material.

Polymer compositions disclosed herein may include a suitable amount of a thermoplastic polyurethane ranging from a lower limit of one of 15 wt %, 20 wt %, 25 wt %, 30 wt %, 35 wt %, 40 wt %, 45 wt %, or 50 wt % and an upper limit of one of 55 wt %, 60 wt %, 65 wt %, 70 wt %, 75 wt %, 80 wt %, 85 wt %, 90 wt %, 95 wt %, 96 wt %, 97 wt % 98 wt %, 99 wt %, or 99.5 wt %, where any lower limit may be combined with any mathematically compatible upper limit.

Polymer compositions in accordance with the present disclosure may include thermoplastic polyurethanes that can be polyester-based, e.g., mainly derived from adipic acid esters, or polyether-based, e.g., such as based on tetrahydrofuran (THF) ethers, polyethylene glycol or polypropylene oxide glycol. Exemplary TPU copolymers are Epamould (Epaflex Poly urethanes S.r.l., Italy), Epaline (Epaflex Polyurethanes S.r.l.), Epacol (Epaflex Polyurethanes S.r.l.), Pakoflex (Epaflex Polyurethanes S.r.l.), Elastollan® (BASF, Michigan), Pearlthane® (Lubrizol, Ohio), Pearlthane® ECO (Lubrizol), Estane® (Lubrizol), Pellethane (Lubrizol), Desmopan (Covestro, Germany), New Power® (New power industrial limited, Hong Kong), Irogran® (Huntsman, Tex.), Avalon® (Huntsman), Exelast EC (Shin-Etsu Polymer Europe B.V., Netherlands), Laripur (C.O.I.M. S.p.A., Italy), Isothane (Greco, Taiwan), Zythane™ (Alliance Polymers & Services, Michigan), and TPU 95A (Ultimaker, Netherlands).

Compatibilizer

The polymer composition may also comprise one or more compatibilizers to facilitate blending the two polymeric components together. Polymer compositions disclosed herein may optionally include a compatibilizer in an amount ranging from a lower limit of one of 0 wt %, 2 wt %, or 4 wt % and an upper limit of one of 6 wt %, 8 wt %, or 10 wt % where any lower limit may be combined with any mathematically compatible upper limit

Suitable compatibilizers include an organic peroxide; a compatibilizing ethylene copolymer; a compatibilizer comprising an epoxy resin and a styrene-based polymer; polycarbonate polyols; polybutadiene polyols; polysiloxane polyols, and combinations thereof.

Suitable organic peroxides include, but are not limited to, 3-hydroxy-1,1-dimethylbutyl peroxyneodecanoate, α-cumyl peroxyneodecanoate, t-amyl peroxyneode canoate, t-butyl peroxyneodecanoate, 2-hydroxy-1,1-dimethylbutyl peroxyneoheptanoate, α-cumyl peroxyneoheptanoate, t-butyl peroxyneoheptanoate, di-(2-ethylhexyl) peroxydicarbonate, di-(n-propyl) peroxydicarbonate, di-(sec-butyl) peroxydicarbonate, t-amyl peroxypivalate, t-butyl peroxypivalate, di-iso-nonanoyl peroxide, di-dodecanoyl peroxide, 3-hydroxy-1,1-dimethyl butylperoxy-2-ethylhexanoate, di-decanoyl peroxide, 2,2′-azobis (isobutyronitrile), di-(3-carboxypropionyl) peroxide, 2,5-dimethyl-2,5-di-(2-ethylhexanoylperoxy) hexane, dibenzoyl peroxide, t-amylperoxy-2-ethylhexanoate, t-butylperoxy-2-ethylhexanoate, t-butyl peroxyisobutyrate, t-butyl peroxy (cis-3-carboxy) propenoate, 1,1-di-(t-amylperoxy) cyclohexane, 1-di-(t-butylperoxy)-3,3,5 trimethylcyclohexane, 1-di(t-butylperoxy) cyclohexane, o-t-amyl-o-(2-ethylhexyl) monoperoxycarbonate, o-t-butyl-o-isopropyl-monoperoxycarbonate, o-t-butyl-o-(2-ethyl-hexyl)monoperoxycarbonate, polyester tetrakis(t-butyl peroxycarbonate), 2,5-dimethyl-2,5-di-(benzoylperoxy)hexane, t-amyl peroxyacetate, t-amyl peroxybenzoate, t-butyl peroxyisononanoate, t-butyl peroxyacetate, t-butyl peroxybenzoate, di-t-butyl diperoxyphthalate, 2,2-di-t-butyl peroxy) butane, 2,2-di-(t-amyloperoxy) propane, n-butyl 4,4 di-(t-butylperoxy) valerate, ethyl 3,3-di-(t-amyloperoxy) butyrate, ethyl 3,3-di-(t-butylperoxy) butyrate, dicumyl peroxide, α,α′-bis-(t-butylperoxy) di-isopropylbenzene, 2,5-dimethyl-2,5-di-(t-butylperoxy)hexane, di-(t-amyl) peroxide, t-butyl a-cumyl peroxide, di-(t-butyl) peroxide, 2,5 dimethyl-2,5-di-(t-butylperoxy)-3-hexane, 3,6,9-triethyl-3,6,9-trimethyl-1,4,7-triperoxinonane, and mixtures thereof.

Suitable compatibilizing ethylene copolymer are those having the formula E-X, E-Y, or E-X-Y, wherein E is ethylene, X is an α,β-ethylenically unsaturated monomer derived from an alkylacrylate, alkylmethacrylate, alkyl vinyl ether, carbon monoxide, sulfur dioxide, or mixtures thereof (wherein each alkyl group independently contains 1-8 car bon atoms), and Y is an α,β-ethylenically unsaturated monomer containing a reactive group that can form a covalent bond with the TPU copolymer component and/or the branched vinyl ester copolymer component. In one embodiment, X is methyl acrylate, ethyl acrylate, ethyl methylacrylate, or butyl acrylate. In one embodiment, Y is glycidyl methacrylate, glycidyl ethylacrylate, or glycidyl butylacrylate. An exemplary compatibilizer is ethylene-methyl acrylate-glycidyl methacrylate (E-MA-GMA) terpolymer.

Suitable compatibilizers comprising an epoxy resin and a styrene-based polymer can be prepared by blending epoxy resins with a styrene-based polymer. The specific epoxy resins utilized can be prepared by reacting an epoxide-containing compound such as epichlorohydrin with a polyhydric compound such as glycerine or a bisphenol in the presence of sufficient basic material to bind the hydrochloric acid to form epoxy-terminated prepolymers. Epoxies may also be prepared by epoxidation of polyolefins with a peroxidizing agent such as peracetic acid. A variety of epoxy resins are available commercially in a wide range of epoxy content, molecular weight, softening point and compositions, which can also be used herein. Suitable styrene-based polymers include, but are not limited to, homopolymers of styrene, a-methylstyrene, and p-methylstyrene; a high-impact polystyrene modified with a rubber-like polymer such as styrene-butadiene copolymer rubbers, ethylene-propylene copolymer rubbers; ethylene-propylene-diene terpolymer rubbers; a styrene-maleic anhydride copolymer; a styrene acrylonitrile copolymer; a styrene-acrylonitrile-butadiene terpolymer; a styrene-methylmethacrylate copolymer, and the like. An exemplary compatibilizer is styrene acrylonitrile (SA)-epoxy.

Suitable ethylene-acrylic copolymer include, but are not limited to, ethylene-acrylic copolymers such as random terpolymer of ethylene, acrylic ester and maleic anhydride (Lotader family).

Suitable polycarbonate polyols include, but are not limited to, polycarbonate polyols such as polycarbonate diol (e.g., poly(propylene carbonate (PPC)-diol) or polycarbonate triol; polycaprolactone polyol; alkoxylated polyol; and mixtures thereof. The polyol can be a diol, triol, tetrol, or any other polyol or combinations thereof. An exemplary compatibilizer is poly(propylene carbonate (PPC)-diol.

Suitable polybutadiene polyols include, but are not limited to, those hydroxyl-functionalized polybutadiene with an average hydroxyl functionality ranging from about 2 to about 3.

Suitable polysiloxane polyols include, but are not limited to, those polymers having a polysiloxane backbone with terminal or pendant hydroxyl groups, for instance, the polybutadiene polyols described in U.S. Pat. No. 5,916,992, which is incorporated herein by reference in its entirety.

Crosslinking Agents

Polymer compositions in accordance with the present disclosure may include one or more crosslinking agents capable of generating free radicals during polymer processing. Polymer compositions in accordance with the present disclosure may optionally include crosslinking agents, in a range from 0 to 10 wt %. The crosslinking agents may be present in an amount ranging from a lower limit of one of 0, 0.001, 0.01. 0.1, 1, 1.5, 2 and 3 wt % and an upper limit of one of 5, 6, 7, 8, 9 or 10 wt % where any lower limit may be combined with any mathematically compatible upper limit.

In one or more embodiments, crosslinking agents may include bifunctional peroxides such as benzoyl peroxide; dicumyl peroxide; di-tert-butyl peroxide; 00-Tert-amyl-0-2-ethylhexyl monoperoxycarbonate; tert-butyl cumyl peroxide; tert-butyl 3,5,5-trimethylhexanoate peroxide; tert-butyl peroxybenzoate; 2-ethylhexyl carbonate tert-butyl peroxide; 2,5-dimethyl-2,5-di (tert-butylperoxide) hexane; 1,1-di (tert-butylperoxide)-3,3,5-trimethylcyclohexane; 2,5-dimethyl-2,5-di(tert-butylperoxide) hexyne-3; 3,3,5,7,7-pentamethyl-1,2,4-trioxepane; butyl 4,4-di (tert-butylperoxide) valerate; di (2,4-dichlorobenzoyl) peroxide; di(4-methylbenzoyl) peroxide; peroxide di(tert-butylperoxyisopropyl) benzene; and the like.

Crosslinking agents may also include peroxides such as benzoyl peroxide, 2,5-di(cumylperoxy)-2,5-dimethyl hexane, 2,5-di(cumylperoxy)-2,5-dimethyl hexyne-3,4-methyl-4-(t-butylperoxy)-2-pentanol, butyl-peroxy-2-ethyl-hexanoate, tert-butyl peroxypivalate, tertiary butyl peroxyneodecanoate, t-butyl-peroxy-benzoate, t-butyl-peroxy-2-ethyl-hexanoate, 4-methyl-4-(t-amylperoxy)-2-pentano1,4-methyl-4-(cumylperoxy)-2-pentanol, 4-methyl-4-(t-butylperoxy)-2-pentanone, 4-methyl-4-(t-amylperoxy)-2-pentanone, 4-methyl-4-(cumylperoxy)-2-pentanone, 2,5-dimethyl-2,5-di(t-butylperoxy)hexane, 2,5-dimethyl-2,5-di(t-amylperoxy)hexane, 2,5-dimethyl-2,5-di(t-butylperoxy)hexyne-3,2,5-dimethyl-2,5-di(t-amylperoxy)hexyne-3,2,5-dimethyl-2-t-butylperoxy-5-hydroperoxyhexane, 2,5-dimethyl-2-cumylperoxy-5-hydroperoxy hexane, 2,5-dimethyl-2-t-amylperoxy-5-hydroperoxyhexane, m/p-alpha, alpha-di[(t-butylperoxy)isopropyl]benzene, 1,3,5-tris(t-butylperoxyisopropyl)benzene, 1,3,5-tris(t-amylperoxyisopropyl)benzene, 1,3,5-tris(cumyl peroxyisopropyl)benzene, di[1,3-dimethyl-3-(t-butylperoxy)butyl] carbonate, di[1,3-dimethyl-3-(t-amylperoxy)butyl]carbonate, di[1,3-dimethyl-3-(cumylperoxy)butyl]carbonate, di-t-amyl peroxide, t-amyl cumyl peroxide, t-butyl-isopropenylcumyl peroxide, 2,4,6-tri(butylperoxy)-s-triazine, 1,3,5-tri[1-(t-butylperoxy)-1-methylethyl]benzene, 1,3,5-tri-[(t-butylperoxy)-isopropyl]benzene, 1,3-dimethyl-3-(t-butylperoxy)butanol, 1,3-dimethyl-3-(t-amylperoxy)butanol, di(2-phenoxyethyl)peroxydicarbonate, di(4-t-butylcyclohexyl)peroxydicarbonate, dimyristyl peroxydicarbonate, dibenzyl peroxydicarbonate, di(isobomyl)peroxydicarbonate, 3-cumylperoxy-1,3-dimethylbutyl methacrylate, 3-t-butylperoxy-1,3-dimethylbutyl methacrylate, 3-t-amylperoxy-1,3-dimethylbutyl methacrylate, tri(1,3-dimethyl-3-t-butylperoxy butyloxy)vinyl silane, 1,3-dimethyl-3-(t-butylperoxy)butyl N-[1-{3-(1-methylethenyl)-phenyl}-1-methylethyl]carbamate, 1,3-dimethyl-3-(t-amylperoxy)butyl N-[1-{3-(1-methylethenyl)-phenyl}-1-methylethyl]carbamate, 1,3-dimethyl-3-(cumylperoxy))butyl N-[1-{3-(1-methylethenyl)-phenyl}-1-methylethyl]carbamate, 1,1-di(t-butylperoxy)-3,3,5-trimethylcyclohexane, 1,1-di(t-butylperoxy)cyclohexane, n-butyl 4,4-di(t-amylperoxy)valerate, ethyl 3,3-di(t-butylperoxy)butyrate, 2,2-di(t-amylperoxy)propane, 3,6,6,9,9-pentamethyl-3-ethoxycabonylmethyl-1,2,4,5-tetraoxacyclononane, n-butyl-4,4-bis(t-butylperoxy)valerate, ethyl-3,3-di(t-amylperoxy)butyrate, benzoyl peroxide, OO-t-butyl-O-hydrogen-monoperoxy-succinate, OO-t-amyl-O-hydrogen-monoperoxy-succinate, 3,6,9, triethyl-3,6,9-trimethyl-1,4,7-triperoxynonane (or methyl ethyl ketone peroxide cyclic trimer), methyl ethyl ketone peroxide cyclic dimer, 3,3,6,6,9,9-hexamethyl-1,2,4,5-tetraoxacyclononane, 2,5-dimethyl-2,5-di(benzoylperoxy)hexane, t-butyl perbenzoate, t-butylperoxy acetate, t-butylperoxy-2-ethyl hexanoate, t-amyl perbenzoate, t-amyl peroxy acetate, t-butyl peroxy isobutyrate, 3-hydroxy-1,1-dimethyl t-butyl peroxy-2-ethyl hexanoate, OO-t-amyl-O-hydrogen-monoperoxy succinate, OO-t-butyl-O-hydrogen-monoperoxy succinate, di-t-butyl diperoxyphthalate, t-butylperoxy (3,3,5-trimethylhexanoate), 1,4-bis(t-butylperoxycarbo) cyclohexane, t-butylperoxy-3,5,5-trimethylhexanoate, t-butyl-peroxy-(cis-3-carboxy)propionate, allyl 3-methyl-3-t-butylperoxy butyrate, OO-t-butyl-O-isopropylmonoperoxy carbonate, OO-t-butyl-O-(2-ethyl hexyl)monoperoxy carbonate, 1,1,1-tris[2-(t-butylperoxy-carbonyloxy)ethoxymethyl]propane, 1,1,1-tris[2-(t-amylperoxy-carbonyloxy)ethoxymethyl]propane, 1,1,1-tris[2-(cumylperoxy-cabonyloxy)ethoxymethyl]propane, OO-t-amyl-O-isopropylmonoperoxy carbonate, di(4-methylbenzoyl)peroxide, di(3-methylbenzoyl)peroxide, di(2-methylbenzoyl)peroxide, didecanoyl peroxide, dilauroyl peroxide, 2,4-dibromo-benzoyl peroxide, succinic acid peroxide, dibenzoyl peroxide, di(2,4-dichloro-benzoyl)peroxide, and combinations thereof.

In one or more embodiments, the crosslinking agents may include polyisocyanates such as Methylene diphenyl diisocyanate (MDI), Toluene diisocyanate (TDI), Hexamethtylene diisocyanate (HMDI); Triallyl isocyanurate (TAIC), trimethylolpropane-tris-methacrylate (TRIM), triallyl cyanurate (TAC), trifunctional (meth)acrylate ester (TMA), N,N′-m-phenylene dimaleimide (PDM), poly(butadiene) diacrylate (PBDDA), high vinyl poly(butadiene) (HVPBD), poly-transoctenamer rubber (TOR) (Vestenamer®), and combinations thereof.

It is also envisioned that the polymer compositions may contain dynamic crosslinks, as a vitrimer, also called “covalent adaptable networks” which are a class of chemically crosslinked polymers, in which an external-stimulus (temperature, stress, pH, etc.) triggers bond-exchange reactions, thereby permitting the change of the network topology while keeping the number of bonds and crosslinks constant. The dynamic covalent bonds present in vitrimers can undergo associative exchange reactions, such that the network topology is able to change, the material relaxes stresses and flows even though the total number of bonds remains constant in time and does not fluctuate at all times and temperatures. A catalyst may facilitate the exchange reactions for the dynamic crosslinks described above. In one or more embodiments, the catalyst is a metal salt selected from the group consisting of metal salts, metal oxides, metal alkoxides, metal acrylates, metal acetyl acetonates, metal hydrides, metal halides. Such metals may include, for example, zinc, tin, magnesium, cobalt, calcium, titanium and zirconium.

Elastomer

Polymers compositions in accordance with one or more embodiments of the present disclosure may include one or more elastomers.

Polymer compositions in accordance with the present disclosure may optionally include an elastomer, in a range from 0 to 60 wt %. The elastomer may be present in an amount ranging from a lower limit of one of 0, 5, 10 and 15 wt % and an upper limit of one of 20, 30, 40, 50 and 60 wt % where any lower limit may be combined with any mathematically compatible upper limit.

Elastomers in accordance with the present disclosure may include one or more of natural rubber, a synthetic rubber, or a mixture thereof. Representative synthetic rubbery polymers include diene based synthetic rubbers, such as homopolymers of conjugated diene monomers, and copolymers and terpolymers of the conjugated diene monomers with monovinyl aromatic monomers and trienes. Exemplary diene-based compounds include, but are not limited to, polyisoprene (IR) such as 1,4-cis-polyisoprene and 3,4-polyisoprene; neoprene; poly styrene; styrene butadiene rubber (SBR); polybutadiene (BR); 1,2-vinyl-polybutadiene; butadiene-isoprene copolymer; butadiene-isoprene-styrene terpolymer; isoprene-styrene copolymer; styrene/isoprene/butadiene copolymers; styrene/isoprene copolymers, emulsion styrene-butadiene copolymer, solution styrene/butadiene copolymers; butyl rubber such as isobutylene rubber; ethylene/propylene copolymers such as ethylene propylene diene monomer (EPDM), ethylene propylene rubber (EPM) or ethylene vinyl acetate (EVA); and blends thereof. A rubber component, having a branched structure formed by use of a polyfunctional modifier such as tin tetrachloride, or a multifunctional monomer such as divinyl benzene, may also be used. Additional suitable rubber components include nitrile rubber, acrylonitrile-butadiene rubber (NBR), silicone rubber (e.g., rubber methylvinyl silicone, dimethyl silicone rubber, etc.), the fluoroelastomers, acrylic rubbers (alkyl acrylate copolymer (ACM), such as ethylene acrylic rubber), epichlorohydrin rubbers, chlorinated polyethylene rubbers such as chloroprene rubbers, chlorosulfonated polyethylene rubbers, hydrogenated nitrile rubber, hydrogenated isoprene-isobutylene rubbers, tetrafluoroethylene-propylene rubbers, and blends thereof.

Foaming Agent

Polymer compositions in accordance with the present disclosure may include one or more foaming agents to produce expanded polymer compositions and foams. Polymer compositions in accordance with the present disclosure may optionally include a foaming agent, in a range from 0 to 20 wt %. The foaming agent may be present in an amount ranging from a lower limit of one of 0, 2, 4, 6 and 8 wt % and an upper limit of one of 10, 12, 14, 16, 18 and 20 wt % where any lower limit may be combined with any mathematically compatible upper limit.

Foaming agents may include solid, liquid, or gaseous foaming agents. In embodiments utilizing solid foaming agents, foaming agents may be combined with a polymer composition as a powder or granulate.

Foaming agents in accordance with the present disclosure may include chemical foaming agents that decompose at polymer processing temperatures, releasing the foaming gases such as N₂, CO, CO₂, and the like. Examples of chemical foaming agents may include organic foaming agents, including hydrazines such as toluenesulfonyl hydrazine, hydrazides such as oxydibenzenesulfonyl hydrazide, diphenyl oxide-4,4′-disulfonic acid hydrazide, and the like, nitrates, azo compounds such as azodicarbonamide, cyanovaleric acid, azobis(isobutyronitrile), and N-nitroso compounds and other nitrogen-based materials, and other compounds known in the art.

Inorganic chemical foaming agents may include carbonates such as sodium hydrogen carbonate (sodium bicarbonate), sodium carbonate, potassium bicarbonate, potassium carbonate, ammonium carbonate, and the like, which may be used alone or combined with weak organic acids such as citric acid, lactic acid, or acetic acid.

Foaming Agent Accelerator

Polymer compositions in accordance with the present disclosure may include one or more foaming accelerators (also known as kickers) that enhance or initiate the action of a foaming agent by lower the associated activation temperature. For example, foaming accelerators may be used if the selected foaming agent reacts or decomposes at temperatures higher than 170° C., such as 220° C. or more, where the surrounding polymer would be degraded if heated to the activation temperature. Foaming accelerators may include any suitable foaming accelerator capable of activating the selected foaming agent. In one or more embodiments, suitable foaming accelerators may include cadmium salts, cadmium-zinc salts, lead salts, lead-zinc salts, barium salts, barium-zinc (Ba—Zn) salts, zinc oxide, titanium dioxide, triethanolamine, diphenylamine, sulfonated aromatic acids and their salts, and the like.

Polymer compositions in accordance with the present disclosure may optionally include a foaming agent accelerator, in a range from 0 to 5 wt %. The foaming agent accelerator may be present in an amount ranging from a lower limit of one of 0, 0.001, 0.1 0.5, and 1 wt % and an upper limit of one of 2, 3, 4 and 5 wt % where any lower limit may be combined with any mathematically compatible upper limit.

Plasticizers

Polymer compositions in accordance with one or more embodiments may include a plasticizer. The plasticizer may be phthalate based, such as: DOP, DOA, DINP, DEHP, DPHP, DIDP, DIOP, DEP, DIBP, and the like, adipate based, such as: DEHA, DMAD, DBS, DBM, DIBM, and the like, bio-based—such as: triethyl citrate, acetyl tributyl citrate, methyl ricinoleate, soybean oil, epoxidized soybean oil, other vegetable oils, and the like, trimellitates, azelates, benzoates, sulfonamides, organophosphates, glycols and polyethers, polymeric plasticizers, polybutene, and the like.

Wax

Polymer compositions in accordance with one or more embodiments may include wax, such as paraffin wax, polyethylene wax, microcrystalline and nanocrystalline wax, natural waxes (bee, carnauba, ceresin, etc.), petroleum waxes, and the like.

Fillers, Nanofillers and Additives

Polymer compositions in accordance with the present disclosure may include fillers, nanofillers and additives that modify various physical and chemical properties when added to the polymer composition during blending that include one or more polymer additives such as processing aids, lubricants, antistatic agents, clarifying agents, nucleating agents, beta-nucleating agents, slipping agents, antioxidants, compatibilizers, antacids, light stabilizers such as HALS, IR absorbers, whitening agents, inorganic fillers, organic and/or inorganic dyes, anti-blocking agents, processing aids, flame-retardants, plasticizers, biocides, adhesion-promoting agents, metal oxides, mineral fillers, glidants, oils, anti-oxidants, antiozonants, accelerators, and vulcanizing agents.

Polymer compositions in accordance with the present disclosure may include one or more inorganic fillers such as talc, glass fibers, marble dust, cement dust, clay, carbon black, feldspar, silica or glass, fumed silica, silicates, calcium silicate, silicic acid powder, glass microspheres, mica, metal oxide particles and nanoparticles such as magnesium oxide, antimony oxide, zinc oxide, inorganic salt particles and nanoparticles such as barium sulfate, wollastonite, alumina, aluminum silicate, titanium oxides, calcium carbonate, polyhedral oligomeric silsesquioxane (POSS), or recycled EVA. As defined herein, recycled EVA may be derived from regrind materials that have undergone at least one processing method such as molding or extrusion and the subsequent sprue, runners, flash, rejected parts, and the like, are ground or chopped. Polymer compositions in accordance with the present disclosure may include one or more nanofillers such as single wall carbon nanotubes, double and multiwall carbon nanotubes, nanocellulose, nanocrystalline cellulose, nanoclays, nanometric metallic or ceramic particles, and the like.

Bio-Based Carbon Content

In polymer compositions of one or more embodiments, the polymer may contain at least a portion of bio-based carbon. Specifically, in one or more embodiments, the polymer composition may exhibit a bio-based carbon content, as determined by ASTM D6866-18 Method B, of from 1% to 100%. Some embodiments may include at least 1%, 5%, 10%, 20%, 40%, 50%, 60%, 80%, or 100% bio-based carbon. The total bio-based or renewable carbon in the polymer composition may be contributed from a bio-based ethylene and/or a bio-based vinyl acetate.

Properties of Thermoplastic Polymer Compositions

When not submitted to crosslinking and/or foaming processes (i.e., when melt blended), the polymer composition prepared by blending the TPU component and the branched vinyl ester-containing ethylene based polymers may have a density ranging from about 0.9 g/cm³ to about 1.7 g/cm³. The density is measured with a standard ASTM D1505. In particular, the incorporation of the branched vinyl ester-containing co-or terpolymer may lower the density, relative to the TPU.

In one or more embodiments, the polymer composition may have one or more glass transition temperatures (Tg) in the range of −100° C. to 180° C. In one or more embodiments, the polymer composition may have one or more glass transition temperatures that ranges from a lower limit of any of −100, −80, −60, −50, −40, −30, −20, −10 or 0° C. to an upper limit of 10, 20, 30, 40, 50, 80, 100, 150, or 180° C., where any lower limit can be paired with any upper limit. Polymer compositions according to the present disclosure may have at least one Tg in the range of −100° C. to 0° C. In one or more embodiments, polymer compositions may present at least a first Tg in the range of −100° C. to 0° C. and at least a second Tg in the range of 100° C. to 180° C. Glass transition temperatures may be measured according to ASTM D7028-07.

Polymer compositions in accordance with one or more embodiments of the present disclosure may have a Shore A hardness as determined by ASTM D2240 that ranges from a lower limit of any of 40, 45, 50, 55, 60 65, or 70 to an upper limit of 70, 75, 80, 85, 90, 93, 95, 96, or 97 Shore A, where any lower limit can be paired with any upper limit.

Polymer compositions in accordance with one or more embodiments of the present disclosure may have a Vicat softening temperature as determined by ASTM D1525 that ranges from a lower limit of any of 60° C., 65° C., 70° C., 75° C., 80° C., 85° C., 90° C., 95° C., 100° C., 105° C., 110° C. or 115° C. to an upper limit of 120° C., 125° C., 130° C., 135° C., 140° C., 145° C., 150° C., 155° C., 160° C., 165° C., 170° C., 175° C., 180° C., 185° C., 190° C. or 200° C., where any lower limit can be paired with any upper limit.

Polymer compositions in accordance with one or more embodiments of the present disclosure may have an elastic modulus at tensile strain of 100% (M100) as determined by ASTM D638 that ranges from a lower limit of any of 300 psi, 400 psi, 500 psi, 600 psi, 700 psi, 800 psi, 900 psi, 1000 psi, 2000 psi, 3000 psi, 4000 psi, or 5000 psi to an upper limit of 2000 psi, 4000 psi, 6000 psi, 7000 psi, 8000 psi, 9000 psi, 10000 psi, 20000 psi or 30000 psi, where any lower limit can be paired with any mathematically compatible upper limit.

In one or more embodiments, polymer compositions may have a lower glass transition temperature and higher abrasion resistance than a reference blend composition consisting essentially of the TPU and a reference EVA at same concentration and same ethylene content as of the ethylene-based polymer in the polymer composition.

In one or more embodiments, polymer compositions may have a reduction in Shore A Hardness, measured according to ASTM D2240, of at least 2% and an increase in elastic modulus at a tensile strain of 100% (M100) of at least 5%, measured according to ASTM D638, as compared to a reference composition consisting essentially of the TPU.

Articles

Polymer compositions in accordance with one or more embodiments of the present disclosure may be used for the production of a number of polymer articles for a diverse array of end-uses, but especially those where a lower glass transition temperature, high abrasion resistance, and decrease in hardness while maintaining tensile properties is desired. In addition, articles of the disclosed compositions may be suitable for applications in the footwear industry in particular shoe soles, midsoles, outsoles, unisoles, insoles, monobloc sandals, flip flops, and sportive articles, automotive product, furniture product, textile product, sports/recreation product, or consumer electronic product.

Exemplary articles include a shoe sole or a shoe part, film, tube, fiber, cable, ear tag, automotive part, automobile part, hose, belt, damping element, armrest, furniture element, ski boot, stop buffer, roller, ski goggle, powder slush, aerials and aerial feet, handles, housing, switch, foam, adhesives, and cladding and cladding element.

Polymer Composition Preparation Methods

In one or more embodiments, polymeric compositions may be prepared by mixture in conventional kneaders, banbury mixers, mixing rollers, twin screw extruders, presses and the like, in conventional polymer processing conditions and subsequently cured (or crosslinked) or cured and expanded in conventional expansion processes, such as injection molding or compression molding.

It is also understood that upon being mixed with the other components forming the polymer composition, the polymer composition may also be cured by, for example, in the presence of crosslinking agents, including those discussed above. For embodiments which include expanded compositions, the expanding and curing may be in the presence of a foaming agent and a crosslinking agent, and optionally, a foaming accelerator.

The polymer composition may be extruded with an extruder that may provide for the injection of a gas, or when a chemical foaming agent is used, the blowing agent may be mixed with the polymer being fed into the extruder. Gas, either injected into the extruder or formed through thermal decomposition of a chemical blowing agent in the melting zone of the extruder. The gas (irrespective of the source of the gas) in the polymer forms into bubbles that distribute through the molten polymer. Upon eventual solidification of the molten polymer, the gas bubble results in a cell structure or foamed material. In particular embodiments, the cell structure of the expanded composition may be a closed cell structure. In other embodiments, the cell structure of the expanded composition may be an open cell structure.

Applications

In one aspect, present disclosure relates to an article comprising the polymer composition. In some embodiments, the article may be an injection molded article, a thermoformed article, a film, a foam, a blow molded article, an additive manufactured article, a compressed article, a coextruded article, a laminated article, an injection blow molded article, a rotomolded article, an extruded article, monolayer articles, multilayer articles, or a pultruded article, and the like.

In some embodiments, the article comprising the polymer composition may be prepared by a process including, but not limited to, extrusion molding, coextrusion molding, extrusion coating, injection molding, compression blow forming, compression molding, injection blow molding, injection stretch blow molding, thermoforming, cast film extrusion, blown film extrusion, blown film process, foaming, extrusion blow molding, injection stretched blow molding, rotomolding, pultrusion, calendering, additive manufacturing, lamination.

In accordance with one or more embodiments of the present disclosure, polymer compositions may be used for the production of a number of polymer articles for a diverse array of end-uses, but especially those where a lower glass transition temperature, high abrasion resistance, and decrease in hardness while maintaining tensile properties is desired. In addition, articles of the disclosed compositions may be suitable for applications in the footwear industry in particular shoe soles, midsoles, outsoles, unisoles, insoles, monobloc sandals, flip flops, and sportive articles, automotive product, furniture product, textile product, sports/recreation product, or consumer electronic product.

Exemplary articles include a shoe sole or a shoe part, film, tube, fiber, cable, ear tag, automotive part, automobile part, hose, belt, damping element, armrest, furniture element, ski boot, stop buffer, roller, ski goggle, powder slush, aerials and aerial feet, handles, housing, switch, foam, adhesives, and cladding and cladding element.

### EXAMPLES

The following examples are merely illustrative and should not be interpreted as limiting the scope of the present disclosure.

Materials

VeoVa™ 10 was purchased from Hexion Inc. Estane® 2355-80AE, a polyester based TPU, and Estane® 2103-80AE, a polyether based TPU, were purchased from Lubrizol. HM728 was obtained from Braskem. G1651 was purchased from Kraton. Lotader® AX8900 was purchased from SK Functional Polymer.

Methods

Shore A hardness was measured as per ASTM D2240.

Vicat softening temperature was measured as per ASTM D1525.

Tensile data were measured as per ASTM D638-98 at a crosshead speed of 2 in/min at 20° C.

Sample morphology was tested using an Atomic Force Microscope (Nanoscope VIII-Bruker). The transversal cut of the center of bar tensile were trimmed in a trapezoidal shape and this region was cryo-ultramicrotomed at −120° C. using diamond knives of 35°. The tapping mode was selected to perform these analyses. Antimony (n) doped Si probes (f0=320 KHz, K=42 N/m) were used to obtain the images. Images were acquired with scan size of 20 μm, 5 μm and 2 μm. Parameters used were: line integral gain and proportional gain or 0.2 and 2.0, a scan rate of 0.2 or 0.5 Hz., a drive frequency of 20.0 mV, and an amplitude setpoint of 8.0 nm.

Melt flow index was measured as per ASTM D1238.

Inventive TPU Blends

Two different ethylene-based polymers comprising ethylene, vinyl acetate and branched vinyl-ester (DV001A and DV001B) were prepared in a high-pressure industrial asset that normally operates producing EVA copolymers. DV001A is a terpolymer comprising 5.6 wt. % of a branched vinyl ester (VeoVa™ 10) and 28.3 wt. % of vinyl acetate; and DV001B is a terpolymer comprising 9.3 wt. % VeoVa™ 10 and 24.1 wt. % of vinyl acetate (the remainder being ethylene). The general reactor conditions for the production of the terpolymers samples are described in Table 1.

TABLE 1

| Parameter | DV001A | DV001B |
|---|---|---|
| Pressure reactor 1 (kgf/cm²) | 1820-1840 | 1820-1840 |
| Temperature reactor 1 (average)(° C.) | 164.5 | 164.5 |
| Pressure reactor 2 (kgf/cm²) | 1780-1800 | 1770-1790 |
| Temperature reactor 2 (average)(° C.) | 161.7 | 163.7 |
| Production rate (kg/h) | 6000 | 6000 |
| Vinyl acetate feed rate (kg/h) | 2850-3200 | 2400 |
| Ethylene feed rate (kg/h) | 4270 | 4300 |
| VeoVa feed rate (kg/h) | 800-900 | 1650 |

Two TPUs were used as a base material to create the examples tested. TPU 1 is a commercial grade polyester based TPU, Estane® 2355-80AE, with a Shore A hardness of 85 and a MI of 7 g/10min (224° C./8.7 kg). TPU 2 is a commercial grade polyether based TPU, Estane® 2103-85AE, with a Shore A hardness of 88 and a MI of 24 g/10min (224° C./8.7 kg).

Lotader® AX8900, a commercial random ethylene-methylacrylate-glycidyl methacrylate terpolymer with a methyl acrylate content of 24 wt. % and a glycidyl methacrylate content of 8 wt. %, was used as a compatibilizer for the blends.

Reference TPU Blends

A comparative polymer used to modify the TPUs was a commercial grade ethylene vinyl acetate (EVA 1), HM728, which has a vinyl acetate content of 28 wt. % and a melt flow rate (MFR) of 6 g/10min (190° C/2.16 kg).

A comparative polymer used to modify the TPUs was a commercial linear triblock copolymer based on styrene and ethylene/butylene (SEB) polymer, G1651 E, which has a bound styrene content of 31.5 wt % and a solution viscosity of 1.5 Pa s as measured by KM06 on 10% m/m solution in toluene at 25° C.

Lotader® AX8900, a commercial random ethylene-methylacrylate-glycidyl methacrylate terpolymer with a methyl acrylate content of 24 wt. % and a glycidyl methacrylate content of 8 wt. %, was used as a compatibilizer for the blends.

Preparation of TPU Blends

The materials for the production of inventive blends and comparative (reference) blends are listed in Table 2 below. The materials were dried overnight at 80° C. in a convection oven prior to compounding in a 25 mm 30 L/D twin screw corotating extruder (NFM) at 190° C. and 350 rpm to produce the blends.

TABLE 2

| Samples | TPU 1 | TPU 2 | DV001A | DV001B | SEB | EVA1 | Compatibilizer |
|---|---|---|---|---|---|---|---|
| Ref. 1 | 100 | — | — | — | — | — | — |
| Ref. 2 | — | 100 | — | — | — | — | — |
| Ref. Blend 1 | 80 | — | — | — | — | 15 | 5 |
| Ref. Blend 2 | 80 | — | — | — | 15 | — | 5 |
| Ref. Blend 3 | — | 85 | — | — | — | 15 | — |
| Ref. Blend 4 | — | 85 | — | — | 15 | — | — |
| Ref. Blend 5 | — | 80 | — | — | — | 15 | 5 |
| Novel Blend 1 | 85 | — | — | 15 | — | — | — |
| Novel Blend 2 | 80 | — | 15 | — | — | — | 5 |
| Novel Blend 3 | 80 | — | — | 15 | — | — | 5 |
| Novel Blend 4 | — | 80 | 15 | — | — | — | 5 |
| Novel Blend 5 | — | 80 | — | 15 | — | — | 5 |

The compounded samples were dried overnight. Then the dried samples were injection molded, with barrel temps at 204° C., pack pressure of 750 psi, injection speed of 2 inches/sec, and a mold temp of 10° C., into ASTM D638 type 1 tensile bars: ⅛-inch×½-inch×6 inch.

The molded samples were annealed for 24 hrs at 80° C. then 48 hrs at 20° C. before testing. Samples were tested for Vicat softening temperature (ASTM D1525), Shore A hardness (ASTM D2240), tensile (ASTM D638 at 2 in/min and 20° C.) and morphology.

Table 3 below shows the Shore A hardness, elastic modulus at a tensile strain of 100% (M100), and Vicat softening temperature results for the samples listed in Table 2.

TABLE 3

| Samples | Shore A Hardness | Vicat (° C.) | M100 (psi) |
|---|---|---|---|
| Ref. 1 | 86.2 | 90.9 | 653 |
| Ref. Blend 1 | 84.2 | 77.2 | 613 |
| Ref. Blend 2 | 84.2 | 77.5 | 620 |
| Novel Blend 1 | 83.7 | 86.8 | 659 |
| Novel Blend 2 | 83 | 104 | 724 |
| Novel Blend 3 | 84.3 | 99.6 | 743 |
| Ref. 2 | 86.3 | 83.4 | 702 |
| Ref. Blend 3 | 82.8 | 86.1 | 622 |
| Ref. Blend 4 | 82.3 | 83.9 | 630 |
| Ref. Blend 5 | 83.7 | 85.2 | 557 |
| Novel Blend 4 | 83.0 | 78.5 | 779 |
| Novel Blend 5 | 83.7 | 83.6 | 588 |

Ref. Blends 1 and 2 show that blending in the EVA 1, SEB, and terpolymers decreases the Shore A hardness of TPU, as expected. A decrease in hardness generally corresponds to a decrease in the Vicat temperature, as seen in Ref. blends 1 and 2. Surprisingly, Novel Blends 2 and 3 exhibit an improvement in Vicat temperature with a decrease in hardness relative to TPU only (Ref. 1). The combination of terpolymer, compatibilizer, and TPU unexpectedly results in an increase in Vicat temperature. Novel blend 1 does not have a compatibilizer however it yielded a lower shore A hardness and higher Vicat than the Refs blends 1 and 2 with SEB and EVA 1 with a compatibilizer. These results suggest that DV001A and DV001B have better compatibility with TPUs compared to SEB and EVA samples.

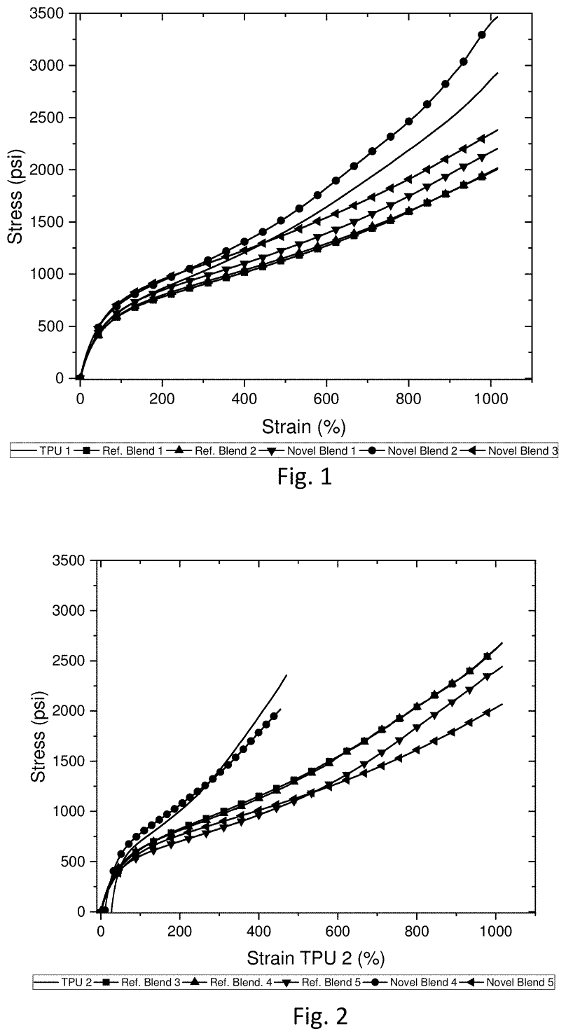

FIG. 1 shows the tensile data for TPU 1 based samples, and FIG. 2 shows the tensile data for TPU 2 based samples. Novel blend 2 and 3 have a higher stress at equivalent elongation than Ref. Blends 1 and 2, and Novel blend 2 outperforms the TPU 1 reference.

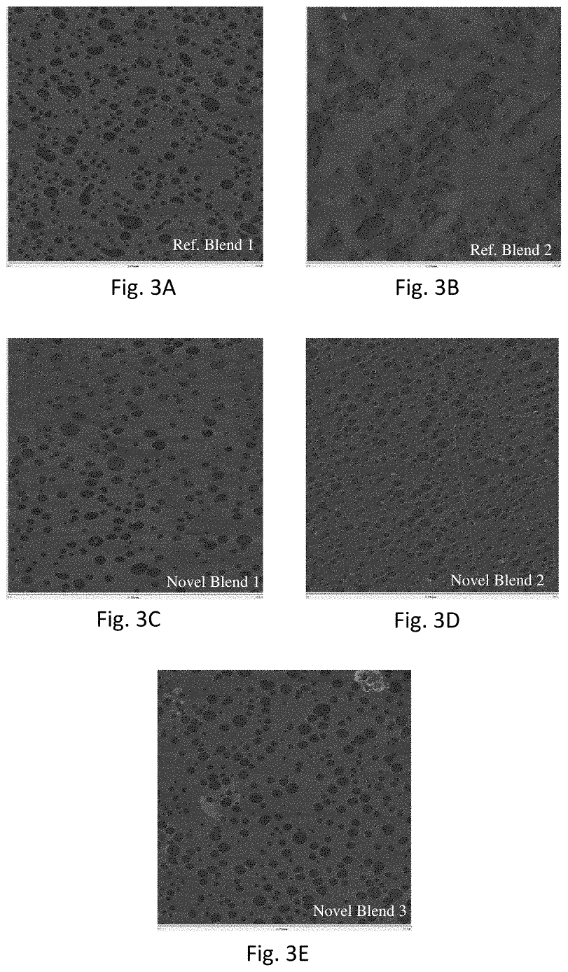

FIGS. 3A and 3B show AFM micrographs of Ref. Blend 1 and Ref. Blend 2 respectively. FIGS. 3C-3E show AFM micrographs of Novel Blend 1, Novel Blend 2, and Novel Blend 3 respectively. The AFM micrographs are the phase signal, which shows the differences of morphology/hardness in the blends. The lighter regions represent the harder TPU matrix, while the dark sections are the different modifiers. The smaller particle size of the modifiers in Novel blend 2 and Novel blend 3 demonstrate DV001A and DV001B have better compatibility with the TPU than the SEB and EVA 1 used in reference blends. This improved compatibility is the likely cause for the improved tensile and Vicat data.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A polymer composition, comprising:
an ethylene based polymer produced from ethylene, one or more branched vinyl ester monomers, and optionally vinyl acetate (VA); and
a thermoplastic polyurethane (TPU).

2. The polymer composition of claim 1, wherein the ethylene based polymer is present in an amount ranging from 0.5 to 85 wt %.

3. The polymer composition of claim 1, wherein the thermoplastic polyurethane is present in an amount ranging from 15 to 99.5 wt %.

4. The polymer composition of claim 1, further comprising a compatibilizer ranging from greater than 0 to 10 wt %.

5. The polymer composition of claim 4, wherein the compatibilizer is a reactive compatibilizer.

6. The polymer composition of claim 4, wherein the compatibilizer is selected from an organic peroxide, an ethylene copolymer, an epoxy resin, an ethylene-acrylic copolymer, a styrene-based polymer, a polycarbonate polyol, polybutadiene polyols, polysiloxane polyols, or a combination thereof.

7. The polymer composition of claim 1, further comprising an elastomer.

8. The polymer composition of claim 7, wherein the elastomer comprises a natural rubber (NR), a synthetic rubber, or a mixture thereof.

9. The polymer composition of claim 8, wherein the synthetic rubber polymer is diene-based comprising homopolymers of conjugated diene monomers, and copolymers, and terpolymers of the conjugated diene monomers with monovinyl aromatic monomers and trienes.

10. The polymer composition of claim 1, wherein the polymer composition is crosslinked.

11. The polymer composition of claim 1, wherein the polymer composition is dynamically crosslinked.

12. The polymer composition of claim 1, wherein the composition is foamed.

13. The polymer composition of claim 1, wherein the ethylene based polymer has vinyl acetate (VA) content ranging from about 0 to about 40 wt %.

14. The polymer composition of claim 1, wherein the TPU is polyester-based or polyether-based.

15. The polymer composition of claim 1, wherein the polymer composition has a density, measured according to ASTM D1505 ranging from 0.9 to 1.7 g/cm³.

16. The polymer composition of claim 1, wherein the polymer composition has a lower glass transition temperature and higher abrasion resistance than a reference blend composition consisting essentially of the TPU and an EVA at same concentration and same ethylene content as of the ethylene based polymer in the polymer composition.

17. The polymer composition of claim 1, wherein the polymer composition has a Shore A Hardness, measured according to ASTM D2240 ranging from 50 Shore A to 96 Shore A.

18. The polymer composition of claim 1, wherein the polymer composition has a reduced Shore A Hardness, measured according to ASTM D2240 of at least 2% lower and an increased elastic modulus at a tensile strain of 100% (M100), measured according to ASTM D638 of at least 5% higher than a reference composition consisting essentially of the TPU.

19. The polymer composition of claim 1, wherein the polymer composition has an elastic modulus at a tensile strain of 100% (M100), measured according to ASTM D638 of at least 300 psi.

20. The polymer composition of claim 1, wherein the polymer composition has a Vicat softening temperature, measured according to ASTM D1525 ranging from 70° C. to 200° C.

21. An article formed from the polymer composition of claim 1.

22. The article of claim 21, wherein the article is selected from the group consisting shoe sole or a shoe part, film, tube, fiber, cable, ear tag, automotive part, automobile part, hose, belt, damping element, armrest, furniture element, ski boot, stop buffer, roller, ski goggle, powder slush, aerials and aerial feet, handles, housing, switch, foam, adhesives, and cladding and cladding element.

23. The article of claim 21, wherein the article is prepared by a method selected from a group consisting of injection molding, compression molding, extrusion molding, 3D printing, foaming, and thermoforming.

24. A method of preparing a polymer composition comprising:
blending a thermoplastic polyurethane (TPU) and an ethylene based polymer produced from ethylene, one or more branched vinyl ester monomers, and optionally vinyl acetate (VA); and to form a blended mixture; and
extruding the blended mixture to form the polymer composition.
